(19) United States
(12) Patent Application Publication
(10) Pub. No.: US 2024/0317103 A1
(43) Pub. Date: Sep. 26, 2024

(54) Energy Sharing Among Battery-Based Chargers for Electric Vehicles

(71) Applicant: FREEWIRE TECHNOLOGIES, INC., Newark, CA (US)

(72) Inventors: Nikola Milivojevic, Boulder, CO (US); John Seabury, Newark, CA (US); Tabish Shibly, Oakland, CA (US); Aaron Rogers, Newark, CA (US); Ravi Teja Lavu, Fremont, CA (US)

(21) Appl. No.: 18/613,796

(22) Filed: Mar. 22, 2024

Related U.S. Application Data
(60) Provisional application No. 63/454,019, filed on Mar. 22, 2023.

(51) Int. Cl. B60L 53/67; B60L 53/53; B60L 53/62

(52) U.S. Cl. CPC B60L 53/67; B60L 53/53; B60L 53/62; B60L 2210/12; B60L 2210/14

(57) ABSTRACT

A charger for an electric vehicle includes a battery system; a high-voltage direct current (HVDC) bus configured to connect the charger to an external battery system; a DC-to-DC converter; and a switching component configured to (i) in a first operational state, connect the battery system to the HVDC bus directly so as to provide a parallel electric connection to the external battery system, and (ii) in a second operational state, connect the battery system to the HVDC bus via the DC-to-DC converter to align a voltage across the battery system with a voltage across the HVDC bus

### CROSS-REFERENCE TO RELATED APPLICATION

This application claims priority to and the benefit of the filing date of provisional U.S. Patent Application No. 63/454,019, titled “Sharing Power Battery Among Multiple Charging Stations,” filed on Mar. 22, 2023. The entire contents of this provisional application are hereby expressly incorporated herein by reference.

### TECHNICAL FIELD

This application generally relates to improvements to charging stations generally and, more particularly, to improvements in energy management and charge transfer between multiple charging stations at a charging site interconnected by a battery bus.

### BACKGROUND

Charging stations for electric vehicles (EVs), referred to below also as “EV Supply Equipment” (EVSEs), “EV chargers,” or simply as “chargers,” provide electric power to EVs, including plug-in hybrid vehicles, that can operate without the use or with limited use of hydrocarbon-based fuels. Installation of conventional charging stations typically requires improvements to infrastructure including upgrades to electrical service and construction of suitable housing. The costs, planning, and time required to install these charging systems can be a deterrent to potential commercial or residential operators. To reduce the installation and operating requirements associated with traditional charging stations, some EV chargers include batteries to store energy received from a power source (such as an electric utility power grid) over an extended time interval. More particularly, a battery-based EV charger incorporates a stationary battery as an energy buffer, storing energy received from an AC grid for example, to prevent the direct supply of DC charging power.

At charging sites having multiple charging stations, different chargers can have different states of charge (SOCs) due to different rates of utilization or other reasons. For example, drivers frequently park and charge at the chargers nearest a location of interest (e.g., an entrance to a business), resulting in higher rates of battery discharging for such chargers. Because the batteries of the chargers are discharged during vehicle charging at a faster rate than they are charged from a power source such as the AC grid, the batteries of the more frequently used chargers may be depleted more quickly than the batteries of charging stations that are less frequently used.

### SUMMARY

Multiple decentralized batteries of respective electric vehicle (EV) charging stations, or simply “chargers,” are disposed at a common site and are interconnected via a bus to effectively operate as one large charger with multiple ports for independently charging multiple EVs. The bus can be implemented as a high-voltage DC (HVDC) bus. Because the voltages at the respective batteries of the chargers can be at different levels, at least some of the chargers include a switching component configured to connect the battery of the charger directly to the bus in one operational state, and connect the battery of the charger to the bus via a DC-to-DC converter in a second operational state. The DC-to-DC in the second operational state operates to transfer energy from the battery of the charger to the one or more batteries of the peer chargers via the bus or from the one or more batteries of the peer chargers to the battery of the charger via the bus, depending on whether the voltage across the battery of the charger is higher or lower than the voltage across the bus. The switching component can include for example power sharing or paralleling contactors and a rebalancing contactor. The chargers further can communicate via wireless or wires communication links to coordinate the respective battery management systems (BMSs) and, in some implementations, receive commands from a virtual BMS that controls multiple chargers at the site. These techniques allow a site to provide the same charging capability at all EV charging ports of the site.

An example embodiment of these techniques is a charger for an electric vehicle. The charger comprises a battery system; a high-voltage direct current (HVDC) bus configured to connect the charger to an external battery system; a DC-to-DC converter; and a switching component configured to (i) in a first operational state, connect the battery system to the HVDC bus directly so as to provide a parallel electric connection to the external battery system, and (ii) in a second operational state, connect the battery system to the HVDC bus via the DC-to-DC converter to align a voltage across the battery system with a voltage across the HVDC bus.

Another example embodiment of these techniques is a charging system comprising a first charger including (i) a first battery system, (ii) a DC-to-DC converter, (iii) at least one port configured to removeably receive connectors of electric vehicles, and (iv) a switching component; a second charger including (i) a second battery system, and (ii) at least one port configured to removeably receive connectors of electric vehicles; and a high-voltage direct current (HVDC) bus coupled to the first charger and a second charger. The switching component is configured to connect the first battery system to the HVDC bus via the DC-to-DC converter to align a voltage across the first battery system with a voltage across the second battery system.

Yet another example embodiment of these techniques is a method implemented in a charger for an electric vehicle. The method includes determining whether a voltage V_{BAT} across a battery system of charger differs from a voltage V_{HVDC} across a high-voltage DC bus to which the charger is connected by at least a threshold amount; when V_{BAT} differs from V_{HVDC} by at least the threshold amount, transferring power between the battery system and the bus to reach a substantial alignment between V_{BAT} and V_{HVDC}; and when V_{BAT} does not differ from V_{HVDC} by at least the threshold amount, connecting the battery system to the bus in parallel.

### BRIEF DESCRIPTION OF THE DRAWINGS

FIG. 1A is a block diagram of an example charging site at which multiple vehicle charging systems, or simply “chargers,” are configured for energy management using a direct current (DC) DC bus;

FIG. 1B is a block diagram of an example electric vehicle charging system configured for DC charge transfer;

FIGS. 2A and 2B are block diagrams of example charging site configured for energy management between multiple vehicle charging systems via a local AC circuit;

FIG. 2C is a block diagram of an example electric vehicle charging system configured for AC charge transfer;

FIG. 3 is a block diagram of an example combined electric vehicle charging system configured for both AC and DC charge transfer;

FIG. 4 is a block diagram of example hardware implementation of a controller that can operate in a system of FIG. 1A-3.

FIG. 5A is a block diagram of an example charger in which a battery supplies power to two independent charging EV ports;

FIG. 5B is a block diagram of a charger similar to that of FIG. 5A, but with additional contactors for connecting multiple stationary batteries to a common battery bus;

FIG. 6A illustrates a system in which multiple chargers connect to a common battery bus, when the switching component of one of the chargers causes the charger to perform a power rebalancing procedure;

FIG. 6B illustrates the system of FIG. 6A, but when the switching component causes the charger to connect in parallel to the common battery bus;

FIG. 7 illustrates a system similar to that of FIG. 6A or 6B, but with a centralized system controller configured to coordinate the operation of switching components at individual chargers;

FIG. 8 is a flow diagram of an example method for balancing the voltage at a charger connected to a common battery bus;

FIG. 9 is a flow diagram of an example method for initiating a power rebalancing procedure for one or more chargers, at a unified virtual battery management system; and

FIG. 10 is a flow diagram of an example method for determining whether one of the chargers should be disconnected from a common battery bus, which also can be implemented in a unified virtual battery management system.

### DETAILED DESCRIPTION

A battery-equipped charger for an electric vehicle (EV) is configured to connect to a battery bus, also referred to below as a high-voltage direct current (HVDC) bus or simply “bus,” to form a unified battery system for EV charging. The charger can use a DC-to-DC converter to transfer energy to or from the battery of the charger to one or more remote batteries connected to the HVDC bus. The techniques of this disclosure solve the problem of ensuring availability of reliable power at each of the charging stations at a multi-charger site.

The techniques discussed below include interconnecting decentralized batteries within charging stations and establishing a unified battery system for independent EV charging. In some cases, this approach leverages the site infrastructure instead of relying on individual batteries, enabling energy sharing among multiple chargers in a networked environment. EV charge ports according connect to, and draw energy from, a single unified system.

Although described below as relating to EVs, it should be understood that the techniques of this disclosure may apply also to plug-in hybrid vehicles or other wholly or partially battery-powered devices that may be charged by a high-voltage or high-power charging station.

### Example System Architecture

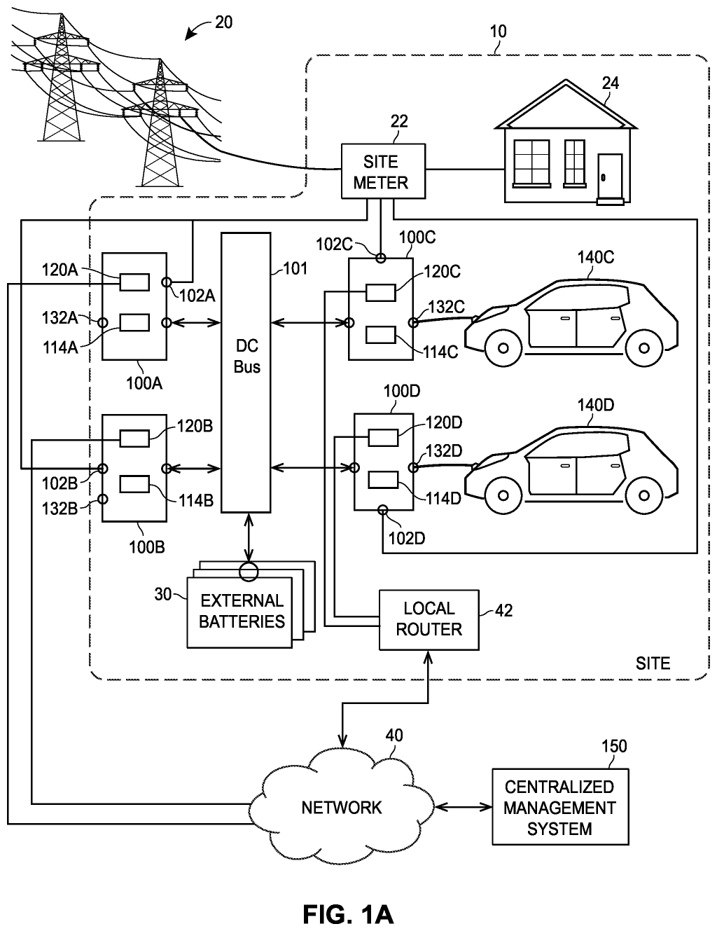

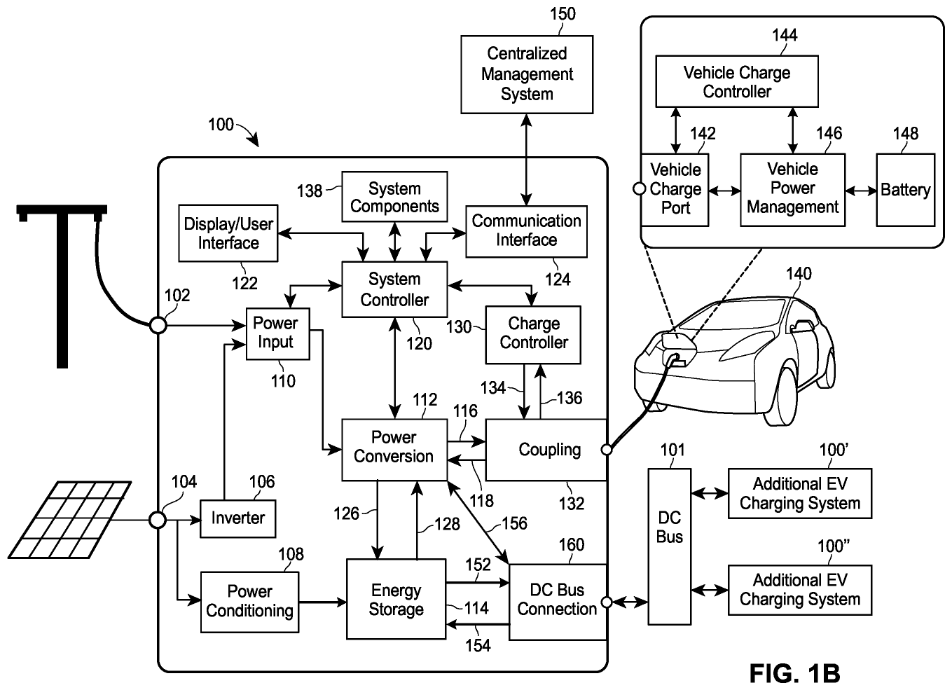

FIG. 1A illustrates a block diagram of an example of a charging site 10 configured for energy management between multiple EV charging systems 100A-D via a DC bus 101. The charging site 10 is supplied with AC power from an electric power grid 20 via a site meter 22, which records power consumption and connects the various electrical components disposed at the charging site 10 to the electric power grid 20. Thus, the electric power grid 20 provides AC power to each of the EV charging systems 100A-D and other electrical components via the site meter 22, including providing AC power to a non-charging load 24 (e.g., commercial building electrical infrastructure) at the charging site 10. In some embodiments, the site meter 22 is a smart meter including additional control logic and communication functionality. For example, the site meter 22 may be configured to communicate with one or more external servers (not show) and/or the centralized management system 150 to obtain demand data regarding load on or demand charges for AC power from the electric power grid 20. In some such embodiments, the site meter 22 may be configured to disconnect part or all of the loads from the electric power grid 20 upon the occurrence of certain conditions (e.g., during peak hours or when the power grid is unstable duc to high demand). In this way, the site meter 22 may be used to separate the charging site 10 from the electric power grid 20 when needed. Although only one site meter 22 is shown, some embodiments may include a plurality of meters, each of which may perform part or all of the operation of the site meter 22. Such embodiments may be implemented to facilitate more targeted control of operations of individual EV charging systems 100 or non-charging loads 24 at the charging site 10.

The AC power from the site meter 22 is provided as an input AC electric power to the respective input ports 102A-D of the EV charging systems 100A-D via one or more wired AC connections. In some embodiments, the input AC electric power is received at each of the input ports 102A-D as a 120V or 240V single-phase or three-phase AC power supply. As discussed elsewhere herein, each of the EV charging systems 100A-D converts and stores such input AC electric power to DC power stored in batteries of respective energy storage modules 114A-D, from which charging currents may be provided to vehicles via vehicle couplings 132A-D of the EV charging systems 100A-D. The EV charging systems 100A-D are controlled by respective system controllers 120A-D, which monitor operating data of the respective EV charging systems 100A-D and control charging and discharging of the energy storage modules 114A-D.

In some embodiments, the DC power may be stored in the energy storage modules 114A-D over an interval of time in order to provide charging current to EVs via respective vehicle couplings 132A-D at a faster rate than the input AC electric power is received by the EV charging systems 100A-D. While this has significant advantages in reducing the electrical infrastructure requirements for the charging site 10, some of the EV charging systems 100A-D may be used more than others. For example, EV charging systems 100C and 100D may experience greater use due to closer proximity to a destination (e.g., by being located in a parking lot at locations nearer an entrance to a commercial building). As illustrated, vehicles 140C and 140D may be connected to EV charging systems 100C and 100D by vehicle couplings 132C and 132D, respectively, in order to receive charging currents from energy stored in the energy storage modules 114C and 114D, while no vehicles are charging at EV charging systems 100A and 100B. Thus, the batteries of EV charging systems 100C and 100D will discharge faster than those of EV charging systems 100A and 100B, resulting in a charge imbalance among the energy storage modules 114A-D. To address such an imbalance, energy may be transferred from EV charging systems 100A and 100B to EV charging systems 100C and 100D via the DC bus 101.

The DC bus 101 provides a direct DC power connection between the EV charging systems 100A-D to enable charge transfers among the energy storage modules 114A-D. Each of the EV charging systems 100A-D includes an inter-charger connection (not shown) that provides a bidirectional DC connection to the DC bus 101, and thereby to each of the other EV charging systems 100A-D. Through such inter-charger connections, the EV charging systems 100A-D are enabled to receive and to provide DC current at various times as part of charge transfers, which may be used to perform charge balancing between the energy storage modules 114A-D. In some embodiments, one or more external batteries 30 are also connected to the DC bus 101 to store energy received from the EV charging systems 100A-D and provide the stored energy at a later time, as needed. Such external batteries 30 may include controllers (not shown) to control charging and discharging, or the external batteries 30 may be controlled by the system controllers 120A-D of the EV charging systems 100A-D or by a centralized management system 150. Similarly, in various embodiments, charge transfers may be determined and controlled by the system controllers 120A-D of the EV charging systems 100A-D or by a centralized management system 150. To facilitate such control decisions, each of the system controllers 120A-D is connected via wired or wireless communication connections with the other system controllers 120A-D and/or with the centralized management system 150 to exchange electronic messages or signals.

The centralized management system 150 may communicate with each of the EV charging systems 100A-D in order to monitor operating data regarding the EV charging systems 100A-D and to determine and control charge transfers as needed. The centralized management system 150 may be located at the charging site 10 or at a location remote from the charging site 10. When remote from the charging site 10, the centralized management system 150 may be communicatively connected to the EV charging systems 100A-D via a network 40, which may be a proprietary network, a secure public internet, a virtual private network, or some other type of network, such as dedicated access lines, plain ordinary telephone lines, satellite links, cellular data networks, or combinations of these. In various embodiments, the EV charging systems 100A-D may be communicatively connected with the network 40 directly or via a local router 42. In some embodiments in which the centralized management system 150 is located at the charging site 10, the centralized management system 150 may be combined with or incorporated within any of the EV charging systems 100A-D. In still further embodiments, the centralized management system 150 may be configured as a local cloud or server group distributed across the system controllers 120A-D of the EV charging systems 100A-D in order to provide robust control in the event of a network disruption.

In some embodiments, the centralized management system 150 may also communicate with remote EV charging systems that are deployed in locations remote from the charging site 10, which locations may be separated by large geographic distances. For example, the centralized management system 150 may communicate with EV charging systems 100 located in different parking facilities, on different floors of the same parking structure, or in different cities. Such centralized management system 150 may comprise one or more servers configured to receive operating data from and to send data and/or control commands to each of the EV charging systems 100A-D. To facilitate communication, the centralized management system 150 may be communicatively connected to the system controllers 120A-D of the EV charging systems 100A-D via an electronic communication link with a communication interface module (not shown) within each of the EV charging systems 100A-D.

The centralized management system 150 may group or relate EV charging systems according to their location, their intended function, availability, operating status, and capabilities. The centralized management system 150 may remotely configure and control the EV charging systems, including the EV charging systems 100A-D. The centralized management system 150 may remotely enforce regulations or requirements governing the operation of the EV charging systems 100A-D. The centralized management system 150 may remotely interact with users of the EV charging systems 100A-D. The centralized management system 150 may remotely manage billing, maintenance, and error detection for each of the EV charging systems 100A-D. For example, error conditions resulting in manual disconnection of a vehicle from any of the EV charging systems 100A-D may be reported by such EV charging system to the centralized management system 150 for analysis. The centralized management system 150 may also communicate with mobile communication devices of users of the EV charging systems 100A-D, such as mobile communication devices or other computing devices used by operators of the EV charging systems 100A-D to enable the operator to self-configure the EV charging systems 100A-D, charge pricing, language localization, currency localization, and so on. Operation of the centralized management system 150 in relation to charge transfers between the EV charging systems 100A-D is further described elsewhere herein.

FIG. 1B illustrates a block diagram of an example of an EV charging system 100 configured in accordance with certain aspects disclosed herein. The EV charging system 100 may be any of the EV charging systems 100A-D at the charging site 10 illustrated in FIG. 1A. The EV charging system 100 is configured to receive electric power from a power source (e.g., electric power grid 20) via an input port 102 or 104 in order to charge an energy storage module 114 (e.g., one or more batteries), from which the EV charging system 100 provides a charging current to a vehicle 140 in order to charge a battery 148 of the vehicle 140. Such charge is provided through a vehicle coupling 132, which may comprise a charging cable utilizing one or more standard connector types (e.g., Combined Charging System (CCS) or Charge de Move (CHaDEMO) connectors). In addition to being connected to one or more power sources via the input ports 102 or 104, the EV charging system 100 includes a DC bus connection 160 to the DC bus 101 at the charging site 10. Through the DC bus connection 160, the EV charging system 100 is configured to send DC power to one or more additional EV charging systems 100′ or 100″ and to receive DC power from such additional EV charging systems 100′ or 100″, as controlled by a system controller 120 of the EV charging system 100. Although the illustrated EV charging system 100 is illustrated as communicating with a centralized management system 150, alternative embodiments of the EV charging system 100 need not be configured for such external communication. Additional or alternative components and functionality may be included in further alternative embodiments of charging systems.

The EV charging system 100 includes a power input module 110 having one or more circuits configurable to transform, condition, or otherwise modify power received from an input port 102 or 104 to provide conditioned power to a power conversion module 112. The input power received at input ports 102 or 104 may be received from an electric power grid 20, a local power generator (e.g., a solar panel or a wind turbine), or any other power source. In some embodiments, input AC power is received at an AC input port 102, while input DC power is received at a DC input port 104 (e.g., from photovoltaic cells or other types of DC power sources). The DC input port 104 may be connected to one or more of an inverter module 106 or a power conditioning module 108 for the input DC power. In further embodiments, DC current received via DC input port 104 is converted to an AC current by an inverter module 106, and the AC current is then provided to power input module 110. The power input module 110 may combine AC or DC current received from multiple sources. Similarly, the power input module 110 may direct AC or DC current received from multiple sources to individual circuits or sections of the power conversion module 112. In some embodiments, the power input module 110 may include a rectifier to convert AC current received at an input port 102 or 104 into DC current to be provided to the power conversion module 112. In further embodiments, DC current received via DC input port 104 may instead be provided to a power conditioning module 108 that may include voltage level converting circuits, filters, and other conditioning circuits to provide a charging current to the energy storage module 114.

The power conversion module 112 includes some combination of one or more AC-to-DC, DC-to-DC, and/or DC-to-AC converters for efficient conversion of AC or DC input power received from a power utility or other source at input port 102 or 104 via the power input module 110 to a DC energy storage current 126 provided to the energy storage module 114, which stores the power until needed to provide a charging current 116 to a vehicle 140. In some embodiments, the power conversion module 112 includes an AC-to-DC conversion circuit that generates a DC energy storage current 126 that is provided to an energy storage module 114. Alternatively, the power input module 110 may include an AC-to-DC conversion circuit to generate a DC current from an input AC electric power. In further embodiments, the energy storage module 114 includes high-capacity batteries that have a storage capacity greater than a multiple of the storage capacity in the EVs to be charged (e.g., three times, five times, or ten times an expected vehicle battery capacity). The storage capacity of the energy storage module 114 may be configured based on the expected average charge per charging event, which may depend upon factors such as the types of vehicles charged, the depletion level of the vehicle batteries when charging starts, and the duration of each charging event. For example, a retail parking site may have more charging events of shorter duration, while a commuter train parking lot may have fewer charging events of longer duration. In various embodiments, the storage capacity of the energy storage module 114 may be configured based on maximum expected charging offset by power received from an electric utility. In some embodiments, the storage capacity of each of the energy storage modules 114 of the EV charging systems 100 and any external batteries 30 at a charging site 10 may be configured to ensure a total charge stored at the charging site 10 is sufficient for an expected maximum load due to vehicle charging. In further embodiments, the power received from an electric utility may be limited to power available during low-demand times, such as off-peak or low-priced periods of the day. The power input module 110 may be configured to block or disconnect inflows of power during peak or high-priced periods of the day. In some embodiments, the power input module 110 may be configured to enable power reception during peak periods to ensure continued operation of the EV charging system 100 when power levels in the energy storage module 114 are unexpectedly low.

In some embodiments, the power conversion module 112 may include one or more DC-to-DC conversion circuits that receive DC current 128 at a first voltage level from the energy storage module 114 and drive a charging current 116 to a vehicle 140 through a vehicle coupling 132 to supply a vehicle 140 with the charging current 116 via a vehicle charge port 142. The vehicle coupling 132 serves as an electrical interconnect between the EV charging system 100 and the vehicle 140. In various embodiments, such vehicle coupling 132 comprises a charging head and/or a charging cable. For example, the vehicle coupling 132 may comprise a charging cable having a standard-compliant plug for connection with a vehicle charge port 142 of vehicles 140. The vehicle coupling 132 may include both a power connection for carrying the charging current 116 and a communication connection for carrying electronic communication between the charge controller 130 and the vehicle 140. In some embodiments, the EV charging system 100 may comprise multiple vehicle couplings 132, and the power conversion module 112 may include a corresponding number of DC-to-DC conversion circuits specific to each of the multiple couplings. According to some embodiments, the power conversion module 112 may be further configured to receive a reverse current 118 from a vehicle 140 via the vehicle coupling 132, which reverse current 118 may be used to provide a DC energy storage current 126 to add energy to the energy storage module 114. In some examples, the power conversion module 112 includes one or more inverters that convert the DC current 128 to an AC current that can be provided as the charging current 116.

A charge controller 130 controls the charging current 116 and/or reverse current 118 through each vehicle coupling 132. To control charging or discharging of the vehicle 140, the charge controller 130 comprises one or more logic circuits (e.g., general or special-purpose processors) configured to execute charging control logic to manage charging sessions with vehicle 140. Thus, the charge controller 130 is configured to communicate with the system controller 120 to control the power conversion module 112 to provide the charging current 116 to the vehicle 140 or to receive the reverse current 118 from the vehicle 140 via the vehicle coupling 132. In some instances, the charge controller 130 may include power control circuits that further modify or control the voltage level of the charging current 116 passed through the vehicle coupling 132 to the vehicle 140. The charge controller 130 also communicates via the vehicle coupling 132 with a vehicle charge controller 144 within the vehicle 140 to manage vehicle charging. Thus, the charge controller 130 communicates with the vehicle charge controller 144 to establish, control, and terminate charging sessions according to EV charging protocols (e.g., CCS or CHaDEMO). The charge controller 130 may be communicatively connected with the vehicle coupling 132 to provide output signals 134 to the vehicle charge controller 144 and to receive input signals 136 from the vehicle charge controller 144.

A system controller 120 is configured to control operations of the EV charging system 100 by implementing control logic using one or more general or special-purpose processors. The system controller 120 is configured to monitor and control power levels received by the power input module 110, power levels output through the charging current 116, energy levels in the energy storage module 114, and charge received from or output to the DC bus 101 via the DC bus connection 160. The system controller 120 is further configured to communicate with and control each of the one or more charge controllers 130, as well as controlling the power conversion module 112. For example, the system controller 120 is configured to control the power conversion module 112 and the charge controller to supply a charging current 116 to the vehicle coupling 132 in response to instructions from the charge controller 130. As discussed further herein, the system controller 120 is also configured to control (either separately or in coordination with the centralized management system 150) charge transfers to manage energy levels of the EV charging system 100 in relation to additional EV charging systems 100′ and 100″ at the charging site 10.

The system controller 120 controls charge transfers by determining occurrence of a triggering condition for a charge transfer and controlling a response to such triggering condition in order to provide or receive DC power via a direct connection with one or more additional EV charging systems 100′ or 100″ provided by the DC bus 101. Thus, the system controller 120 controls receiving DC input from and providing DC output to the DC bus 101 via a DC bus connection 160 of the EV charging system 100 in order to effect charge transfers at the charging site 10. The DC bus connection 160 serves as an inter-charger connection of the EV charging system 100 and is configured to connect the EV charging system 100 to the DC bus 101 at the charging site 10 as a direct connection for the exchange of DC power between the EV charging system 100 and additional EV charging systems 100′ and 100″ (e.g., other EV charging systems of the EV charging systems 100A-D) at the charging site 10, as well as with any external batteries 30 at the site 10 (as illustrated in FIG. 1A). In some embodiments, the DC bus connection 160 receives and provides DC power via a DC link 156 with the power conversion module 112, with the power conversion module 112 being controlled by the system controller 120 to manage any voltage or current requirements of the energy storage module 114 or the DC bus 101. In additional or alternative embodiments, the DC bus connection 160 may directly interface with the energy storage module 114 in order to provide a DC output current 152 from the energy storage module 114 to the DC bus 101 and to provide a DC input current 154 from the DC bus 101 to the energy storage module 114, as controlled by the system controller 120.

The system controller 120 is also configured to communicate with other various system components 138 of the EV charging system 100 (e.g., other controllers or sensors coupled to the energy storage module 114 or other components of the EV charging system 100) in order to receive operating data and to control operation of the system via operation of such system components 138. For example, the system controller 120 may monitor temperatures within the EV charging system 100 using the system components 138 and may be further configured to mitigate increases in temperature through active cooling or power reductions using the same or different system components 138. Likewise, the system controller 120 communicates with a user interface module 122 (e.g., a touchscreen display) and a communication interface module 124 (e.g., a network interface controller) to provide information and receive control commands. Each communication interface module 124 may be configured to send and receive electronic messages via wired or wireless data connections, which may include portions of one or more digital communication networks.

The system controller 120 is configured to communicate with the components of the EV charging system 100, including power input module 110, power conversion module 112, the user interface module 122, the communication interface module 124, the charge controller 130, and the system components 138 over one or more data communication links. The system controller 120 may also be configured to communicate with external devices, including a vehicle 140 via the vehicle coupling 132, one or more additional EV charging systems 100′ and 100″ via the centralized management system 150, one or more external batteries 30, or a site meter 22. The system controller 120 may manage, implement or support one or more data communication protocols used to control communication over the various communication links, including wireless communication or communication via a local router 42. The data communication protocols may be defined by industry standards bodies or may be proprietary protocols.

The user interface module 122 is configured to present information related to the operation of the EV charging system 100 to a user and to receive user input. The user interface module 122 may include or be coupled to a display with capabilities that reflect intended use of the EV charging system 100. In one example, a touchscreen may be provided to present details of charging status and user instructions, including instructions describing the method of connecting and disconnecting a vehicle 140. The user interface module 122 may include or be coupled to a touchscreen that interacts with the system controller 120 to provide additional information or advertising. The system controller 120 may include or be coupled to a wireless communication interface that can be used to deliver a wide variety of content to users of the EV charging system 100, including advertisements, news, point-of-sale content for products/services that can be purchased through the user interface module 122. The display system may be customized to match commercial branding of the operator, to accommodate language options and for other purposes. The user interface module 122 may include or be connected to various input components, including touchscreen displays, physical input mechanisms, identity card readers, touchless credit card readers, and other components that interact through direct connections or wireless communications. The user interface module 122 may further support user authentication protocols and may include or be coupled to biometric input devices such as fingerprint scanners, iris scanners, facial recognition systems and the like.

In some embodiments, the energy storage module 114 is provisioned with a large battery pack, and the system controller 120 executes software to manage input received from a power source to the battery pack based upon demand level data (e.g., demand or load data from an electric power grid 20 or site meter 22), such that power is drawn from the power source to charge the battery pack at low-load time periods and to avoid drawing power from the grid during peak-load hours. The software may be further configured to manage power output to provide full, fast charging power in accordance with usage generated by monitoring patterns of usage by the EV charging system 100. The use of historical information can avoid situations in which the battery pack becomes fully discharged or depleted beyond a minimum energy threshold. For example, charging may be limited at a first time based upon a predicted later demand at a second time, which later demand may be predicted using historical information. This may spread limited charging capacity more evenly among vehicle throughout the course of a day or in other situations in which battery pack capacity is expected to be insufficient to fully charge all EVs over a time interval, taking account of the ability to add charge to the energy storage module 114.

In further embodiments, the system controller 120 executes software (either separately or in coordination with the centralized management system 150) to manage energy draw and use by controlling charging and discharging over time among multiple EV charging systems 100 at the charging site 10. Thus, the charge drawn from the power source may be limited or avoided during peak-load hours by charge transfer between the EV charging system 100 and one or more additional EV charging systems 100′ and 100″ via the DC bus 101 at the charging site 10, effectively pooling the energy stored in the batteries of all of the charging systems at the charging site 10. As noted above, in some embodiments, the charging site 10 may include one or more external batteries 30 connected to the DC bus 101. In such embodiments, the systems controller 120 and/or the centralized management system 150 may further manage energy inflow and outflow at the charging site 10 by controlling selective charging and discharging such batteries at appropriate time periods to avoid or reduce total power draw of the charging site 10 from the power source during peak-demand or other high-demand times by charging the batteries of the EV charging systems 100 and the external batteries 30 during low-demand times. In some such embodiments, such energy management enables the EV charging system 100 to continue charging vehicles 140 even when the power source is disconnected or unavailable (e.g., when a local power grid is down). As discussed further elsewhere herein, the systems controllers 120 of the EV charging systems 100 and/or the centralized management system 150 may further manage site-wide energy use by controlling charge transfers based upon differential charge levels or discharge levels associated with differential utilization of the various EV charging system 100 at the charging site 10 in order to effect charge balancing or to ensure sufficient charge availability for charging vehicle 140 at one or more of the EV charging systems 100.

In some embodiments, the EV charging system 100 may be configured with two or more vehicle couplings 132 to enable concurrent charging of multiple vehicles 140. The system controller 120 may be configured by a user via the user interface module 122 to support multiple modes of operation and may define procedures for charge transfer or power distribution that preserve energy levels in the energy storage module 114 when multiple vehicles 140 are being concurrently charged. Charge transfers may be used to transfer power from EV charging systems 100 that have available power or are not being used to charge a vehicle 140 to EV charging systems 100 that are charging one or more vehicles 140. Distribution of power may be configured to enable fast charging of one or more vehicles 140 at the expense of other vehicles 140. In this regard, the vehicle couplings 132 may be prioritized or the system controller 120 may be capable of identifying and prioritizing connected vehicles 140. In some instances, the system controller 120 may be configured to automatically control the respective charge controllers 130 to split available power between two vehicles 140 after the second vehicle 140 is connected. The available power may be evenly split between two vehicles 140 or may be split according to priorities or capabilities. In some examples, the system controller 120 may conduct arbitration or negotiation between connected vehicles 140 to determine a split of charging capacity. A vehicle 140 may request a charging power level at any given moment based on temperature, battery charge level, and other characteristics of the vehicle 140 and its environment and to achieve maximum charge rate and minimum charging time for the current circumstances.

As illustrated, a vehicle 140 may be charged by connecting the vehicle 140 to the EV charging system 100 via a vehicle coupling 132. This may include plugging a charging cable of the EV charging system 100 into a vehicle charge port 142 of the vehicle 140. The vehicle charge port 142 is configured to receive the charging current 116 through the vehicle coupling 132 and provide such received current to a vehicle power management module 146. The vehicle charge port 142 is further configured to provide an electronic communication connection between the vehicle coupling 132 and a vehicle charge controller 144, which controls charging of the vehicle 140. The vehicle power management module 146 is controlled by the vehicle charge controller 144 to provide power to each of one or more batteries 148 of the vehicle 140 in order to charge such battery 148. In some instances, the vehicle charge port 142 includes a locking mechanism to engage and retain a portion of the vehicle coupling 132 in place during charging sessions. For example, for safety reasons, the vehicle charge controller 144 may control a locking mechanism of the vehicle charge port 142 to lock a plug of a charging cable in the vehicle charge port 142 while a charging session is active.

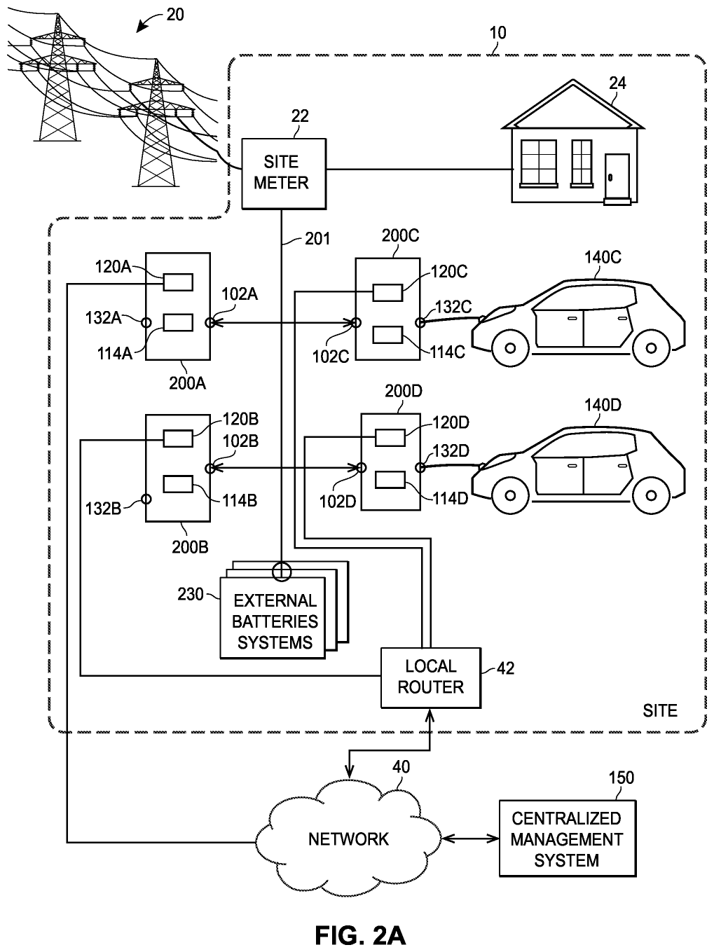

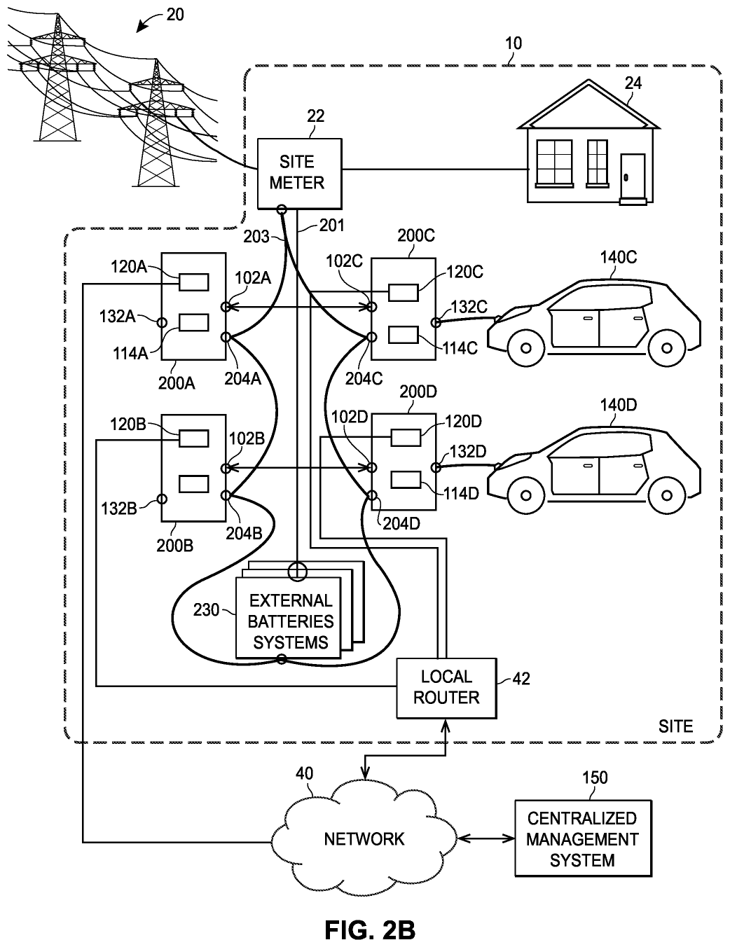

FIGS. 2A-B illustrate block diagrams of examples of a charging site 10 configured for energy management between multiple EV charging systems 200A-D via a local AC circuit 201 or 203. The configurations of the systems and components shown in FIGS. 2A-B are similar to those shown in FIG. 1A, but the EV charging systems 200A-D are configured and connected to transfer charge as AC current over a local AC circuit 201 or 203, rather than as DC current over the DC bus 101. Accordingly, each of the EV charging systems 200A-D receives input AC electric power at respective input ports 102A-D from the electric power grid 20 via the site meter 22 and a local AC circuit 201. The EV charging systems 200A-D rectify the input AC electric power into DC electric power to charge batteries of their respective energy storage modules 114A-D, which may then be used to provide charging currents to vehicles via vehicle couplings 132A-D (as shown with respect to vehicles 140C and 140D). The site meter 22 also provides AC power from the electric power grid 20 to the non-charging load 24 (e.g., commercial building electrical infrastructure) at the charging site 10. Operation of each of the EV charging systems 200A-D is controlled by their respective system controllers 120A-D, which are communicatively connected to the centralized management system 150, either directly or via the network 40, which may include a connection via a local router 42 at the charging site 10.

As discussed elsewhere herein, the EV charging systems 200A-D are configured and controlled by the system controllers 120A-D and/or the centralized management system 150 to transfer charge via local AC circuit 201 or 203 as needed to improve the balance of energy storage and energy demand at each of the EV charging systems 200A-D. To achieve such energy transfers, the DC power provided by one or more of the energy storage modules 114A-D is converted to an AC current by an inverter (not shown) and provided to the local AC circuit 201 or 203 in order to transfer energy to one or more other energy storage modules 114A-D. The respective system controllers 120A-D of the donor EV charging systems 200A-D may be configured to control the phase of the AC output power to the local AC circuit 201 or 203 to match that of the input AC electric power from the site meter 22 or of other donor EV charging systems 200A-D. As noted above, the input AC electric power may be received at each of the input ports 102A-D as a 120V or 240V single-phase or three-phase AC power supply. In various embodiments, the AC output power at input ports 102A-D or input ports 204A-D may be provided according to the same or different voltage and phase combinations.

FIG. 2A illustrates an embodiment in which one local AC circuit 201 carries both the input AC electric power from the electric power grid 20 via the site meter 22 and AC charge transferred between the EV charging systems 200A-D. In such embodiments, the respective input ports 102A-D serve to both receive AC current from the local AC circuit 201 and provide AC current to the local AC circuit 201. In some such embodiments, the local AC circuit 201 may be further connected to one or more non-charging loads 24 at the charging site 10 in order to provide AC power to such non-charging loads 24 when the electric power grid 20 is disconnected or unavailable.

FIG. 2B illustrates an embodiment in which a separate local AC circuit 203 carries AC current for energy transfers among the EV charging systems 200A-D, while the local AC circuit 201 carries the input AC electric power from the electric power grid 20. As illustrated, the local AC circuit 201 may be connected to each of the EV charging systems 200A-D via respective input ports 102A-D, while the local AC circuit 203 may be connected to each of the EV charging systems 200A-D via the respective input ports 204A-D. Such separation of the local AC circuits 201 and 203 may be advantageous in some situations by enabling charge transfers at higher power than the input AC electric power from the electric power grid 20 or while such input AC electric power is being received from the electric power grid 20. In some embodiments, the local AC circuit 203 is also connected to the site meter 22. In some such embodiments, the site meter 22 may receive AC power from the local AC circuit 203 and provide such AC power to one or more non-charging loads 24 at the charging site 10 in order to provide AC power to such non-charging loads 24 when the electric power grid 20 is disconnected or unavailable.

In some embodiments, the local AC circuit 201 and/or 203 also connects one or more external battery systems 230 to the EV charging systems 200A-D in order to increase the storage capacity at the charging site 10. Such external battery systems 230 may receive input AC power from the electric power grid 20 via local AC circuit 201 and/or from the EV charging systems 200A-D via local AC circuit 203 in order to charge one or more batteries (not shown) of the external battery systems 230. Such external battery systems 230 may include various components (not shown), including controllers and bidirectional inverters or separate rectifiers and inverters in order to convert the input AC power into DC power for storage and later convert the stored DC power into output AC power for charge transfers to one or more of the EV charging systems 200A-D.

FIG. 2C illustrates a block diagram of an example of an EV charging system 200 configured in accordance with certain aspects disclosed herein. The EV charging system 200 may be any of the EV charging systems 200A-D at the charging site 10 illustrated in FIGS. 2A-B. The components and configuration of the EV charging system 200 shown in FIG. 2C are similar to those of the EV charging system 100 shown in FIG. 1B, but the EV charging system 200 is configured for transferring charge to an additional EV charging system 200′ as AC current over a local AC circuit 201 or 203 via one or more of the input ports 102 or 104, rather than as DC current over the DC bus 101 via the DC bus connection 160. Accordingly, the power input module 110 of EV charging system 100 is replaced with a bidirectional inverter 210, which is connected to provide DC power to the power conversion module 112 and is further connected to receive input AC power from and to provide output AC power to the input ports 102 and 204. As illustrated, the EV charging system 200 also lacks the inverter module 106 and power conditioning module 108 to receive input DC electrical energy from DC input port 104 of the EV charging system 100, but such components may be included in some embodiments of the EV charging system 200. Other components of the EV charging system 200 are as described above with respect to the EV charging system 100. Additional or alternative components and functionality may be included in further alternative embodiments of charging systems.

The bidirectional inverter 210 is configured to alternatively operate in an inverter mode or in a rectifier mode at various times as controlled by the system controller 120. In the rectifier mode, the bidirectional inverter 210 converts an input AC current from a power source (e.g., the electric power grid 20 or an additional EV charging system 200′ via a local AC circuit 201 or 203) into a DC current to provide to the energy storage module 114 via the power conversion module 112. In the inverter mode, the bidirectional inverter 210 convers a DC current from the energy storage module 114 via the power conversion module 112 into an output AC current to the local AC circuit 201 or 203 via an input port 102 or 204. Thus, when a triggering condition occurs to cause the EV charging system 200 to provide an AC output power to the local AC circuit 201 or 203 to transfer charge to an additional EV charging system 200′ at the charging site 10 (e.g., to enable the additional EV charging system 200′ to charge a vehicle 140′), the bidirectional inverter operates in the inverter mode to convert a DC current from the power conversion module 112 into the AC output power and provide such AC output power to the local AC circuit 201 or 203 via an input port 102 or 204. In some embodiments, a plurality of separate components may instead be configured to perform such functionality of the bidirectional inverter 210, such as by including one or more inverters and rectifiers in the EV charging system 200. In further embodiments, part or all of the functionality of the bidirectional inverter 210 may be incorporated into the power conversion module 112, or part or all of the functionality of the power conversion module 112 may be incorporated into the bidirectional inverter 210.

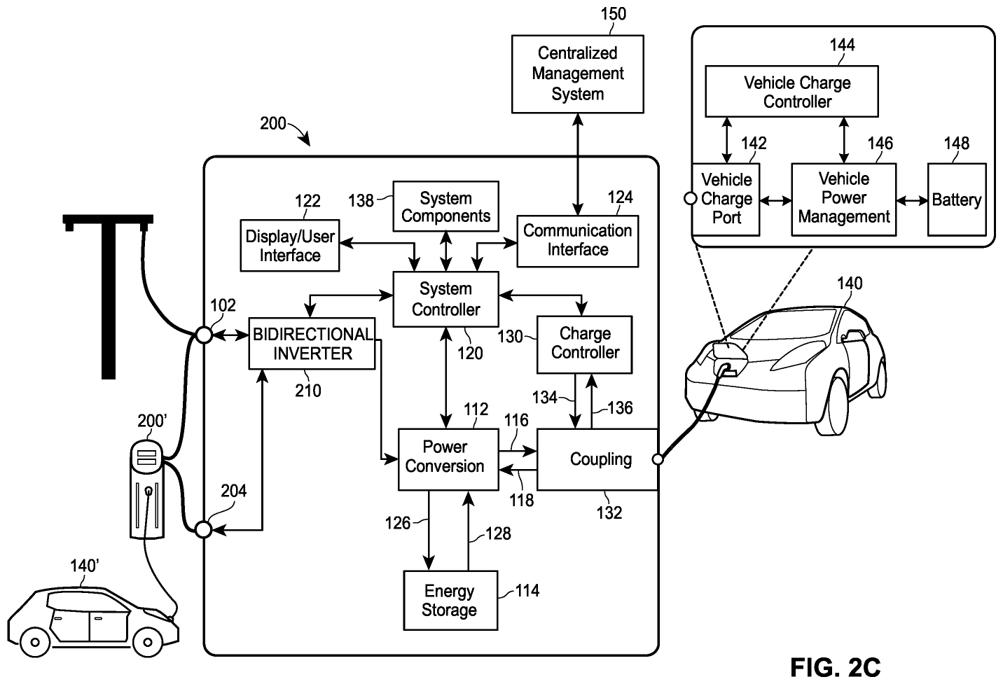

FIG. 3 illustrates a block diagram of an example of a combined EV charging system 300 configured for both AC and DC charge transfer in accordance with certain aspects disclosed herein. The EV charging system 300 may be any of the EV charging systems 100A-D or EV charging systems 200A-D at the charging sites 10 illustrated in FIG. 1A or FIGS. 2A-B. The components and configuration of the EV charging system 300 shown in FIG. 3 combine those of the EV charging system 100 shown in FIG. 1B and those of the EV charging system 200 shown in FIG. 2C. Thus, the EV charging system 300 is configured for transferring charge to additional EV charging system 300′ via a local AC circuit 201 or 203 (e.g., to enable the additional EV charging system 200′ to charge a vehicle 140′) and for transferring charge to additional EV charging systems 300″ and 300′″ via DC bus 101 (e.g., to enable the additional EV charging system 300″ to charge a vehicle 140′″). As illustrated, the EV charging system 300 includes the bidirectional inverter 210 of EV charging system 200, rather than the power input module 110 of EV charging system 100. As further illustrated, the EV charging system 300 also lacks the inverter module 106 and power conditioning module 108 to receive input DC electrical energy from DC input port 104 of the EV charging system 100, but such components may be included in some embodiments of the EV charging system 300. Other components of the EV charging system 300 are as described above with respect to the EV charging system 100 or EV charging system 200. Additional or alternative components and functionality may be included in further alternative embodiments of charging systems.

### Example Controller

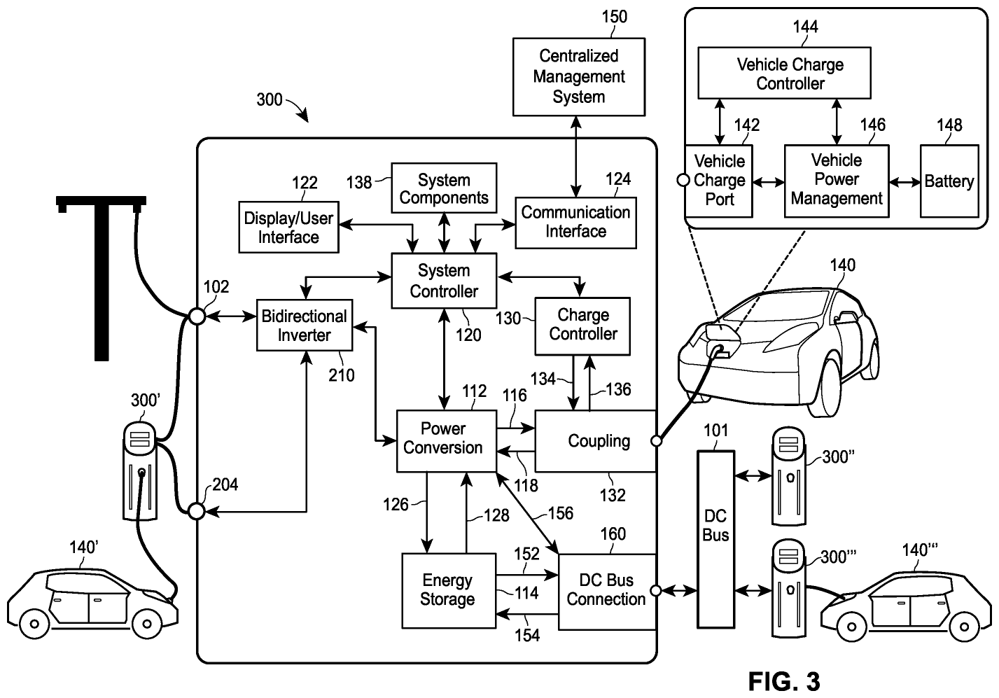

FIG. 4 illustrates a block diagram illustrating a simplified example of a hardware implementation of a controller 400, such as any of the system controller 120, the charge controller 130, the vehicle charge controller 144, or the centralized management system 150 disclosed herein. In some embodiments, the controller 400 may be a controller of a site meter 22, an external battery 30, an external battery system 230, or any other component disclosed herein that implements control logic to control any aspect of the described systems and methods. The controller 400 may include one or more processors 404 that are controlled by some combination of hardware and software modules. Examples of processors 404 include microprocessors, microcontrollers, digital signal processors (DSPs), application-specific integrated circuits (ASICs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 404 may include specialized processors that perform specific functions, which may be configured by one or more of the software modules 416. The one or more processors 404 may be configured through a combination of software modules 416 loaded during initialization and may be further configured by loading or unloading one or more software modules 416 during operation.

In the illustrated example, the controller 400 may be implemented with a bus architecture, represented generally by the bus 410. The bus 410 may include any number of interconnecting buses and bridges depending on the specific application of the controller 400 and the overall design constraints. The bus 410 links together various circuits including the one or more processors 404 and storage 406. Storage 406 may include memory devices and mass storage devices, any of which may be referred to herein as computer-readable media. The bus 410 may also link various other circuits, such as timing sources, timers, peripherals, voltage regulators, and power management circuits. A bus interface 408 may provide an interface between the bus 410 and one or more line interface circuits 412, which may include a line interface transceiver circuit 412a and a radio frequency (RF) transceiver circuit 412b. A line interface transceiver circuit 412a may be provided for each networking technology supported by the controller. In some instances, multiple networking technologies may share some or all of the circuitry or processing modules found in a line interface circuit 412, such as line interface transceiver circuit 412a for wired communication and RF transceiver circuit 412b for wireless communication. Each line interface circuit 412 provides a means for communicating with various other devices over a transmission medium. In some embodiments, a user interface 418 (e.g., touchscreen display, keypad, speaker, or microphone) may also be provided, and may be communicatively coupled to the bus 410 directly or through the bus interface 408.

A processor 404 may be responsible for managing the bus 410 and for general processing that may include the execution of software stored in a computer-readable medium that may include the storage 406. In this respect, the processor 404 of the controller 400 may be used to implement any of the methods, functions, and techniques disclosed herein. The storage 406 may be used for storing data that is manipulated by the processor 404 when executing software, and the software may be configured to implement any of the methods disclosed herein.

One or more processors 404 in the controller 400 may execute software. Software may include instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 406 or in an external computer readable medium. The external computer-readable medium and/or storage 406 may include a non-transitory computer-readable medium. A non-transitory computer-readable medium includes, by way of example, a magnetic storage device (e.g., hard disk, floppy disk, magnetic strip), an optical disk, a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Portions of the computer-readable medium or the storage 406 may reside in the controller 400 or external to the controller 400. The computer-readable medium and/or storage 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 406 may maintain software maintained or organized in loadable code segments, modules, applications, programs, etc., which may be referred to herein as software modules 416. Each of the software modules 416 may include instructions and data that, when installed or loaded on the controller 400 and executed by the one or more processors 404, contribute to a run-time image 414 that controls the operation of the one or more processors 404. When executed, certain instructions may cause the controller 400 to perform functions in accordance with certain methods, algorithms, and processes described herein.

Some of the software modules 416 may be loaded during initialization of the controller 400, and these software modules 416 may configure the controller 400 to enable performance of the various functions disclosed herein. For example, some software modules 416 may configure internal devices or logic circuits 422 of the processor 404, and may manage access to external devices such as line interface circuits 412, the bus interface 408, the user interface 418, timers, mathematical coprocessors, etc. The software modules 416 may include a control program or an operating system that interacts with interrupt handlers and device drivers to control access to various resources provided by the controller 400. The resources may include memory, processing time, access to the line interface circuits 412, the user interface 418, etc.

One or more processors 404 of the controller 400 may be multifunctional, whereby some of the software modules 416 are loaded and configured to perform different functions or different instances of the same function. For example, the one or more processors 404 may additionally be adapted to manage background tasks initiated in response to inputs from the user interface 418, the line interface circuits 412, and device drivers. To support the performance of multiple functions, the one or more processors 404 may be configured to provide a multitasking environment, whereby each of a plurality of functions is implemented as a set of tasks serviced by the one or more processors 404 as needed or desired. In one example, the multitasking environment may be implemented using a timesharing program 420 that passes control of a processor 404 between different tasks, whereby each task returns control of the one or more processors 404 to the timesharing program 420 upon completion of any outstanding operations or in response to an input such as an interrupt. When a task has control of the one or more processors 404, the processing circuit is effectively specialized for the purposes addressed by the function associated with the controlling task. The timesharing program 420 may include an operating system, a main loop that transfers control on a round-robin basis, a function that allocates control of the one or more processors 404 in accordance with a prioritization of the functions, or an interrupt-driven main loop that responds to external events by providing control of the one or more processors 404 to a handling function.

### Example Components for Sharing Power Between Charging Stations

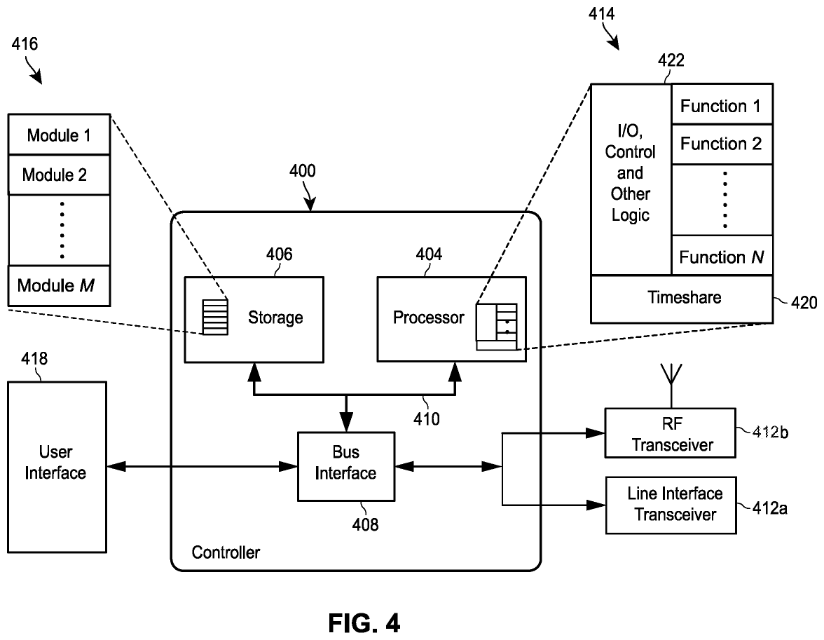

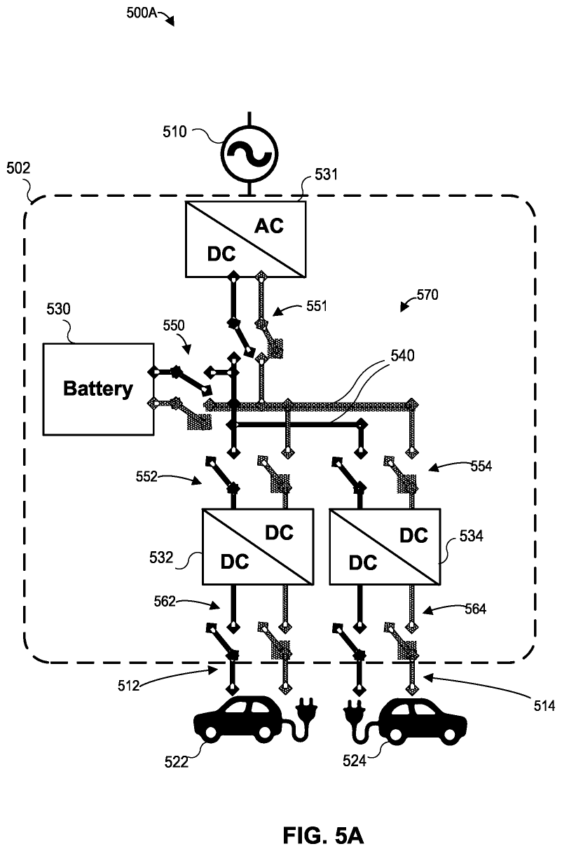

Referring to FIG. 5A, an EV charger 500A connects to an AC grid 510 and provides power at independent charging EV ports 512 and 514. The EV charger 500A includes a housing 502 enclosing a stationary battery system 530, an AC-to-DC converter 531 to receive AC power from the AC grid 510 and transfer the received power to the battery 530, and independent DC-to-DC converters 532, 534 corresponding to the EV charge ports 512 and 514. The battery system 530 can include any suitable number of batteries or cells. The DC-to-DC converters 532, 534 adjust the voltage of the stationary battery 530 to match the EV charging voltage for each EV charging port, as requested by an EV 522 at the EV charging port 512 and an EV 524 at the EV charging port 514. More specifically, the DC-to-DC converters 532, 534 step up or step down the voltage to ensure optimal charging conditions for the EVs 522 and 524.

In this example implementation, the battery 530, the AC-to-DC converter (or inverter) 531, and the DC-to-DC converters 532, 534 are interconnected via a battery bus 540, operating as a central hub. The battery bus 540 also can be understood as a DC link of the charger 500A.

The EV charger 500A can include battery contactors 550 configured to open or close a circuit including the battery 530 and the battery bus 540; inverter contactors 551 configured to open or close a circuit including the inverter 531 and the battery bus 540; port 1 contactors 562 configured to open or close a circuit including the EV charging port 512 and the DC-to-DC converter 532; port 2 contactors 564 configured to open or close a circuit including the EV charging port 514 and the DC-to-DC converter 534; DC link contactors 572 configured to open or close a circuit including the DC-to-DC converter 532 and the HVDC bus 540; and DC link contactors 574 configured to open or close a circuit including the DC-to-DC converter 534 and the battery bus 540.

The contactors 550, 551, 552, 554, 562, and 564 collectively define a switching component 570. The switching component 570 can operate as a part of a control system of the EV charger 500A, which can also include voltage and/or current sensors, insulation monitoring devices, HVDC fuses to protect against short circuits on the battery bus 540.

The architecture of FIG. 5A supports secure decoupling of the stationary battery 530 from the components 530, 531, 532, and 534, thereby ensuring enhanced safety and operational flexibility.

When multiple instances of the EV charger 502A are present at a site, each charger operates independently of the others. In particular, the EV charging ports of each charger are linked to a single respective stationary charger battery, and the charging capability of a charger depends on the SOC of the corresponding battery. Consequently, EVs arriving at the site may see different power levels at different chargers.

Now referring to FIG. 5B, an EV charger 500B addresses this challenge by supporting an interconnection in parallel with other EV chargers to form a unified battery bank. According to this configuration, the independent DC-DC converters of EV chargers can draw power from the unified battery system to charge EVs via the respective ports. The EV charges collectivity utilize the total energy available at the site, and thus support efficient and flexible charging of electric vehicles.

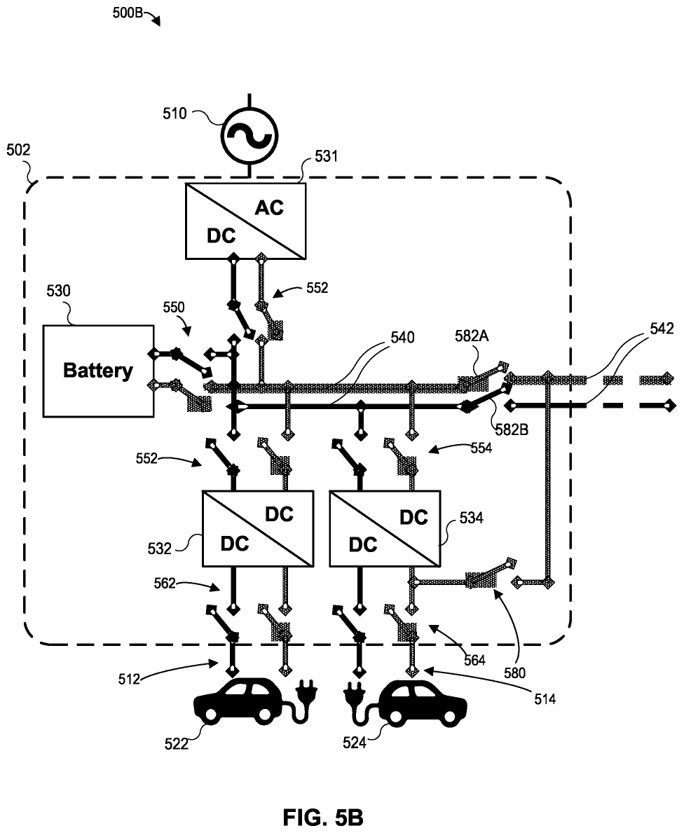

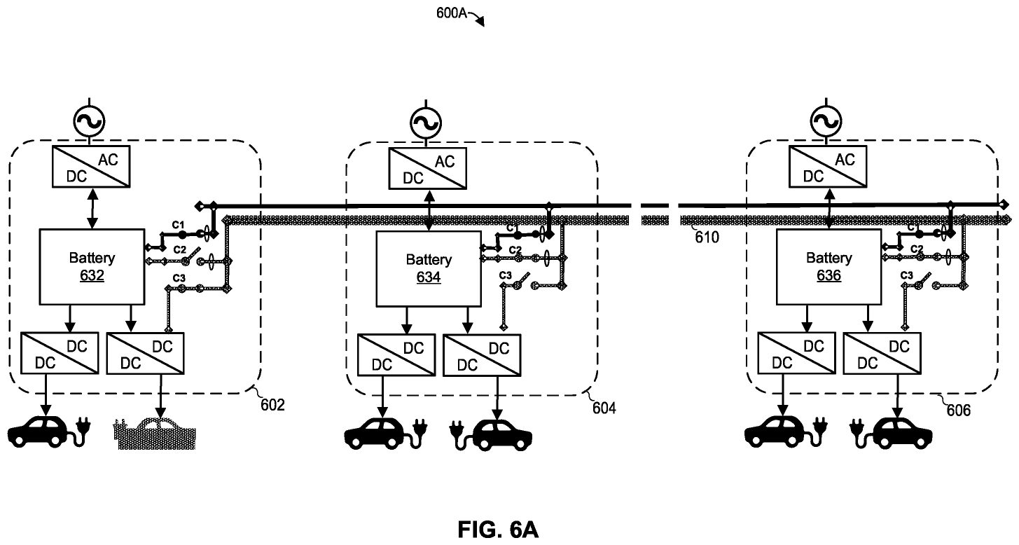

The EV charger 500B is generally similar to the EV charger 500A, but the EV charger 500B also includes a rebalancing contactor 580 and power sharing or paralleling contactors 582A-B. The battery bus 540 extends to an HVDC bus or DC link 542, via which the EV charger 500B is connected to a peer EV charger, as discussed below with reference to FIGS. 6A-B. The battery busses from each EV charger are connected in parallel to form a common bus, which also can be referred to as the “DC link.” The contactors 580, 582A, and 582B are integrated into the EV charger 500B (e.g., are disposed inside the housing 502), to eliminate the need for external hardware or site upgrades.

In an example implementation, the EV charger 500B supports a 3″ conduit to land DC link wiring; the EV charger 500B supports up to four conductors (2 IN, 2 OUT), and the conductors are sized so as to support a continuous current of 320 Amps at 800 VDC with a maximum allowable voltage drop of 1V; and wires are landed at bus bars using ring terminals with a 5/16″ stud.

When the rebalancing contactor 580 is open, the battery 530 is connected to the DC-to-DC converter 534 so as to provide power at EV charging port 514. Further, when the rebalancing contactor 580 is open, and the power sharing contactors 582A and 582B are closed, the battery 530 is connected in parallel to the HVDC bus 542. When the rebalancing contactor 580 is closed, and the power sharing contactors 582B is open, the DC-to-DC converter 534 does not provide power at EV charging port 514. Instead, the battery 530 is connected to the HVDC bus 542 via the DC-to-DC converter 534, which operates to substantially align the voltage across the battery 530 with the voltage across the HVDC bus 542.

Although the EV charger 500B is illustrated in FIG. 5B in a simplified manner to facilitate the discussion of power sharing, the EV charger 500B also can include at least some of the components discussed with reference to example EV charging systems of FIGS. 1A and 1B. Thus, the EV charger 500B can also include a system control, a display/user interface, etc. As a more specific example, the system controller of the EV charger 500B can be similar to the system controller 120, and can implement a battery management system (BMS).

Now referring to FIG. 6A, EV chargers 602, 604, and 606 with stationary batteries 632, 636, and 636, respectively, are connected via a common HVDC bus 610. Each of the EV chargers 602, 604, and 606 can be implemented as the EV charger 500B of FIG. 5B.

In an example configuration 600A, the rebalancing contactor (labeled as contactor C3) of the EV charger 602 is closed, the rebalancing contactor of the EV charger 604 is open, and the rebalancing contactor of the EV charger 606 is open. One of the paralleling contactors (labeled as contactor C1) of the EV charger 602 is closed, but the other paralleling contactor (labeled as contactor C2) of the EV charger 602 is open. The paralleling contactors of the EV chargers 604 and 606 are closed. Thus, in the example configuration 600A, the battery 632 of the EV charger 604 is going through a rebalancing procedure to align with the voltage across the HVDC bus 610, and accordingly with the voltage across the batteries 634, 636 of the EV chargers 604, 606, respectively. More specifically, the DC-DC converter of the EV charger 602 adjusts the voltage across the battery 632 to the match the voltage across the HVDC bus 610. During the procedure, the paralleling contactor C2 remains open, and the rebalancing contactor remains closed.

During the rebalancing procedure, the EV chargers 604 maintains availability of the EV charging port of the DC-to-DC converter that operates independently of the rebalancing contactor (e.g., the DC-to-DC converter 532 of FIG. 5B), while the charging port of the DC-to-DC converter that connected to the rebalancing contactor (e.g., the DC-to-DC converter 534 of FIG. 5B) is unavailable for charging an EV during the rebalancing procedure. At the EV chargers 604 and 606, both EV charging ports are available during the rebalancing procedure. Thus, when the EV chargers 602 is equipped with two DC-to-DC converters, the availability of EV charging ports is at 50% during the rebalancing procedure, and the availability of the other EV charging ports at the site is 100%.

In an example scenario, the EV charger 602 is a new charger introduced to the site that already includes the EV chargers 604 and 606, after a new installation or service. The battery 632 of the EV charger 602 is at a different voltage level than the batteries 634 and 636. The rebalancing procedure aligns the voltage across the battery 632 with the rest of the site.

As a more specific example, the unified battery system of FIG. 6A prior to the addition of the EV charger 602 has a DC link voltage (i.e., the voltage across the HVDC bus 610) of 770V, which may be for example the 80% SOC level. The new EV charger 602 is at 720V, or at the 60% SOC level. To synchronize with the unified battery system, the EV charger 602 must charge up to match the voltage of the unified battery system, i.e., until the voltages of the new EV charger 602 and of unified battery system are equalized, reaching approximately 750V, corresponding to the SOC level of approximately 74%.

With continued reference to FIG. 6A, it is possible for the some of the chargers 602, 604, and 606 to not have an AC grid connection (temporarily or permanently) and rely on the DL link 610 for battery charging. In some implementations, this approach involves additional components such as an AC generator to provide an initial AC source during boot-up and energize the control system.

FIG. 6B illustrates an example configuration 600B in which the voltage across the battery 632 has reached substantial alignment with the voltage across the HVDC bus 610. Here, the rebalancing contactor of the EV charger 602 is open, and the paralleling contactor C2 is closed. Thus, the operational states of the contactors C1, C2, and C3 are the same at all the EV chargers 602, 604, and 606. The batteries 632, 634, and 636 are connected in parallel.

In an example scenario, a unified battery system that includes only two EV charges (such the EV chargers 500B, 602, 604, or 606) interconnected via a DC link (such as the HVDC bus 542 or 610) has a voltage of 770V across the DC link, which can be the 80% SOC level, and which in turn can correspond to 251.2 kWh. When a new EV charger with a voltage of 720V (or the 60% SOC level corresponding to 94.2 kWh) is connected to the DC link, the updated parameters for the DC link become the following: (i) the energy is 345.4 kWh for the unified battery system, or 115.13 kWh for the induvial batteries, (ii) the SOC is 73.33%, and (iii) the voltage is 748V. Thus, the unified battery system must transfer 20.93 kWh of energy from the DC link to the battery of the new EV charger. Assuming the charge current limit (CCL) of the battery of the new EV charger corresponds to 50 Kw, the total time required for equalization in this example is 20.93 kWh/50 KW, which is approximately 25 minutes.

After all the batteries of the EV chargers 602, 604, and 606 are connected in parallel via the DC link 710 to form the unified battery system, the induvial BMSs of the EV chargers can collectively implement, or provide data to, a unified virtual BMS. The unified virtual BMS can utilize data collected from the individual BMSs to implement decision-making processes related to the unified battery system. For example, the unified virtual BMS can determine the discharge current limit (DCL) as the minimum discharge current limit among all the batteries connected to the DC Link 710. Similarly, the unified virtual BMS can determine the charge current limit (CCL) as the minimum charge current limit of the individual EV charges. The unified virtual BMS can apply similar principles to managed faults observed at the individual EV chargers.

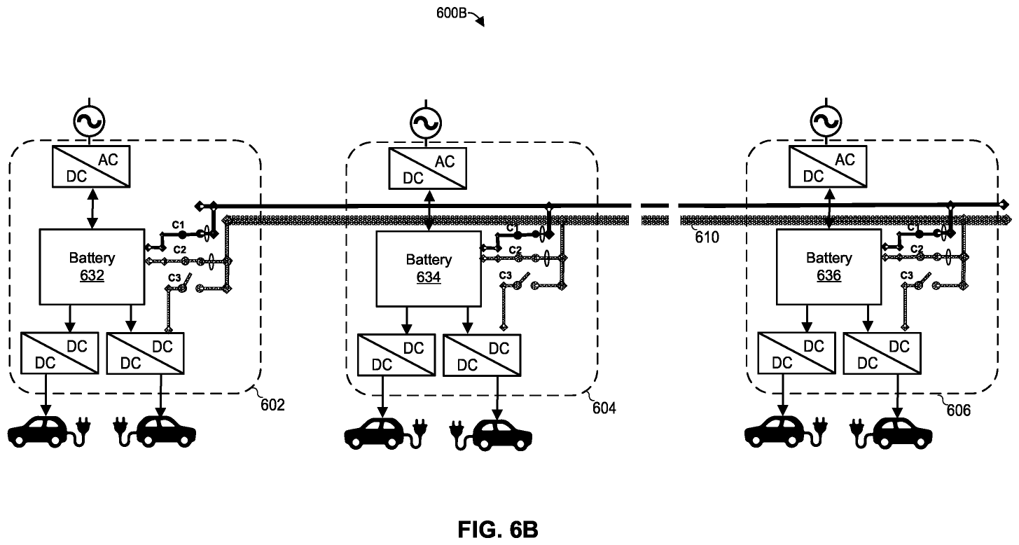

Referring to FIG. 7, a system 700 is similar to that of FIGS. 6A and 6B, but here a system controller 790 can receive data and provide commands to the EV chargers 702, 704, and 706 via respective communication modules 792, 794, and 796. Each of the EV chargers 702, 704, and 706 can be implemented similar to the EV charger 500B, 602, 604, or 606 discussed above (with the addition of a communication module). The communication modules 792, 794, and 796 can implement wireless local area network (WAN), wireless personal area network (WPAN), or wired communications. The system controller 790 can be implemented in a gateway device for example. The system controller 790 can implement at least some of the functionality of the unified virtual BMS.

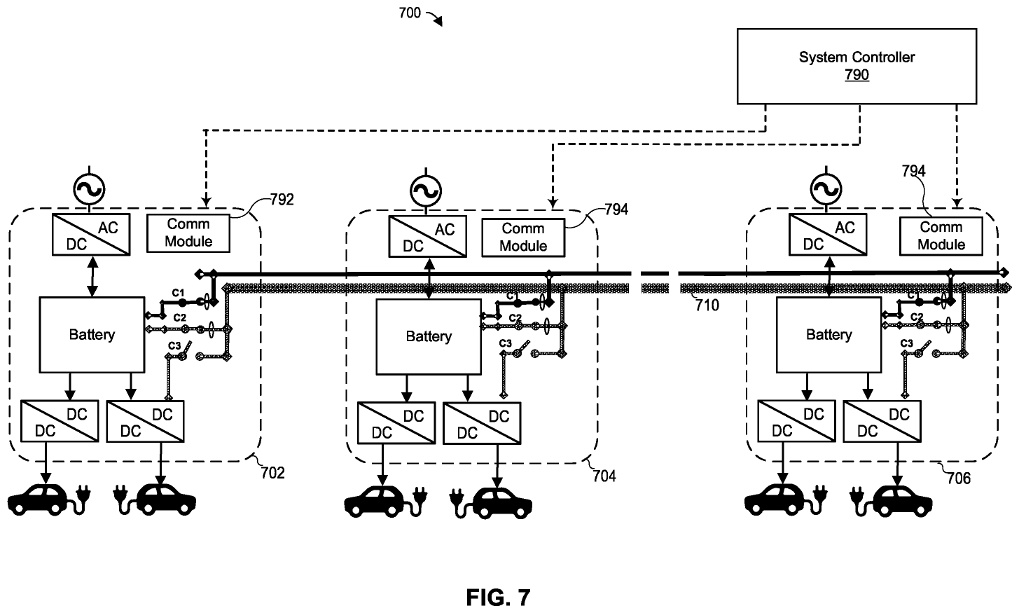

Next, FIG. 8 illustrates an example method 800 for balancing the voltage at an EV charger (e.g., the charger 500B, 602, 604, 606, 702, 704, or 706) connected to a common battery bus or a DC link (e.g., the bus 542, 610, 710). The method 800 can be implemented in the BMS of an EV charger or in a unified virtual BMS, for example. For simplicity, the method 800 is discussed with reference to a BMS which can be EV-charger-specific or unified, depending on the implementation. The method 800 can be implemented as a set of software instructions stored on a non-transitory computer-readable medium and executable by one or more processors.

At block 802, the BMS determines voltage V_{HVDC} across the HVDC bus or the DC link. As discussed above, the EV chargers can be equipped with various sensors, or a sensor can operate on the HVDC bus externally to all the EV chargers (e.g., on the DC link 610 or 710). At block 804, the BMS determines voltage V_{BAT} across the battery of an EV charger. Next, at block 810, the BMS determines whether V_{HVDC} and V_{BAT} differ by at least a threshold amount, which for example can be a configuration parameter expressed in terms of voltage (e.g., 5V, 10V, 15V) or a percentage (e.g., 1%, 2%, 5%).

When the V_{HVDC} and V_{BAT} differ by at least a threshold amount, the flow proceeds to block 820, where the BMS causes the rebalancing contactor (e.g., the contactor 580 of FIG. 5B) to close, so as to connect the battery to the HVDC bus via a DC-to-DC converter. At block 822, the BMS causes the power sharing or paralleling contactor to open (e.g., the contactor 582B), to disconnect the parallel connection between the battery and the HVDC bus. Thus, at blocks 820 and 822, the BMS initiates the rebalancing procedure to raise or lower the voltage across the battery of the EV charger to the voltage across the HVDC bus.

At optional block 824, the BMS stops providing charge at an EV charging port of the DC-to-DC converter involved in the rebalancing procedure (e.g., the DC-to-DC converter 534). At optional block 826, the BMS continues providing charge at an EV charging port of the DC-to-DC converter that is not involved in the rebalancing procedure (e.g., the DC-to-DC converter 532). At block 828, the BMS continues monitoring the difference between V_{HVDC} and V_{BAT}, until these voltages reach a substantial alignment (e.g., until these voltages are within a certain threshold distance, expressed in terms of Volts or a percentage).

The flow then proceeds to block 840. Further, when the BMS at block 810 determines that V_{HVDC} and V_{BAT} do not differ by at least a threshold amount, the flow proceeds from block 810 to block 840. At block 840, the BMS causes the rebalancing contactor to open, and the paralleling or power sharing contactor to close, so that the battery connects to the HVDC bus in parallel and directly, without the DC-to-DC converter. The BMS also can resume supplying charge at the EV charging port of the DC-to-DC converter used during the rebalancing procedure.

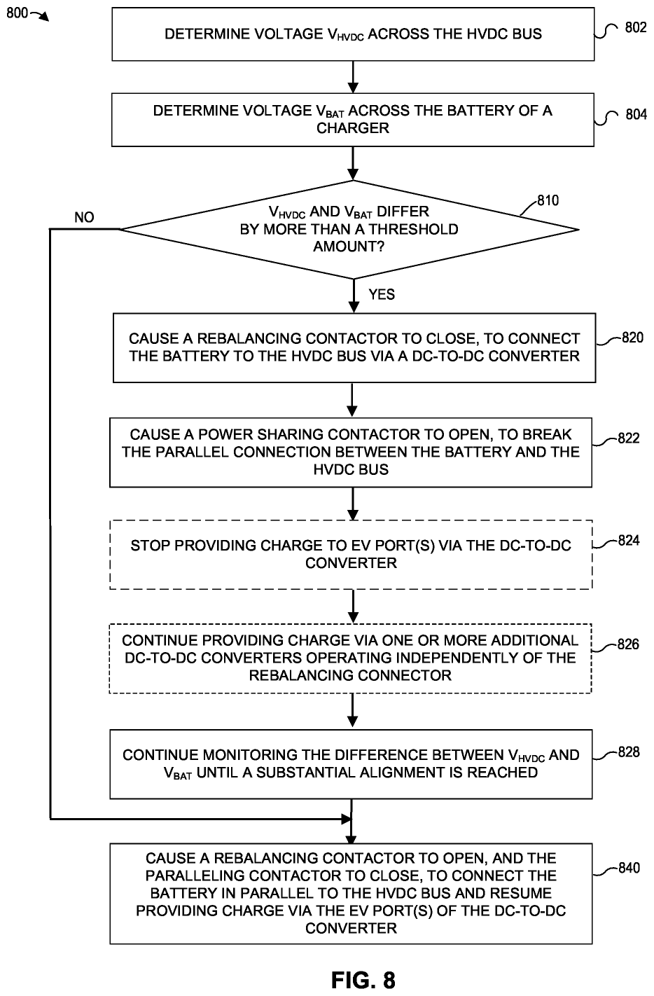

Next, FIG. 9 is a flow diagram of an example method 900 for initiating a power rebalancing procedure for one or more chargers, which can be implemented at a unified virtual BMS. At block 902, the unified virtual BMS determines the respective voltages across the chargers connected to an HVDC bus, also referred to in this disclosure as a DC link. At block 904, the unified virtual BMS determines the respective charge current limits (CCLs) of the EV chargers. At block 906, the unified virtual BMS initiates the rebalancing process in view of the determined CCLs. For example, the unified virtual BMS can control the operation of the corresponding DC-to-DC converter so as to comply with the minimum CCL requirement among the EV chargers connected to the HVDC bus.

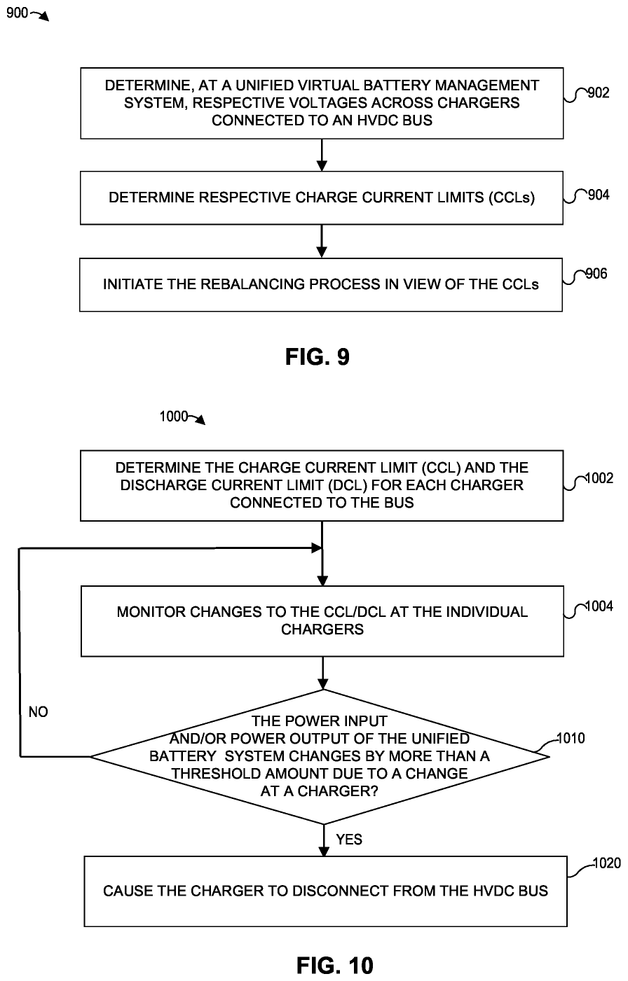

FIG. 10 is a flow diagram of an example method 1000 for determining whether one of the chargers should be disconnected from a common battery bus, which also can be implemented in a unified virtual VMS. At block 1002, the unified virtual BMS determines the CCL and the discharge current limit (DCL) for each charger connected to the HVDC bus. At block 1004, the unified virtual BMS monitors changes to the CCL and/or DCL at the individual chargers. If, at block 1010, the unified virtual BMS determines that the power input and/or the power output of the unified battery system changes more than a threshold amount due to the change in the CCL and/or DCL at a charger, the flow proceeds to block 1020, where the unified virtual BMS causes the charger to disconnect from the HVDC bus. In some implementations, the unified virtual BMS disconnects a certain EV charger by sending a command to the BMS of the EV charger. In another implementation, the unified virtual BMS disconnects the EV charger by directly operating the switching module of the EV charger, e.g., by opening the paralleling contactors (e.g., the contactors 582A and 582B in FIG. 5B). Otherwise, the flow proceeds from block 1010 to block 1004, where the unified virtual BMS continues to monitor changes to the CCL/DCL.

To appreciate the effects of the DLC of the unified battery system, an example scenario can be considered in which a unified battery system includes three EV charges connected in parallel, with a DC Link voltage of 700V. If the individual DCL for each charger is 110 A for example, the aggregated DCL is determined as the minimum of DCL1, DCL2, and DCL3, multiplied by the number of chargers. In this case, this product is 330 A. The maximum power that can be sourced from the DC Link for EV charging is thus 330 A×700V=231 kW.

However, if DCL1 from one the chargers drops down to 95A, the overall aggregated DCL drops to the minimum of 95A, 110A, and 110A multiplied by the number of chargers (in this example, three), which is equal to 285 A. The maximum power that can be sourced from the DC link for EV charging is thus 285 A×700V=199.5 kW. This is a reduction in the maximum power output.

Thus, if the DCL becomes excessively low and significantly restricts power output (see block 1010), the unified virtual BMS may determine that it is advantageous to disconnect the corresponding charger from the DC link (see block 1020).

Further, to appreciate the effects of the CCL of the unified battery system, an example scenario can be considered in which a unified BMS includes three EV chargers connected in parallel with a DC Link voltage of 700V. The individual CCL for each charger is 70 A, and the aggregated CCL is determined as the minimum of CCL1, CCL2, and CCL3, multiplied by the number of chargers, which in this example is 210 A. The maximum power that can be provided to charge up the DC link for EV charging is 210 A×700V=147 kW.

However, if CCL1 from one the chargers drops to 45 A, the overall aggregated CCL drops to the minimum of 45 A, 80 A, and 80 A multiplied by 3, which equals 135 A. The maximum power that can be sourced from the DC Link for EV charging is 135 A×700V=94.5 kW. This is a reduction in the rate of charge and an increase in the overall charge time for the unified battery system.

Thus, if the CCL becomes excessively low and significantly restricts power input (see block 1010), the unified virtual BMS may determine that it is advantageous to disconnect the corresponding charger from the DC link (see block 1020).

### Other Considerations

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. No claim element is to be construed as a means plus function unless the element is expressly recited using the phrase “means for.”

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Unless specifically stated otherwise, the term “some” refers to one or more. Likewise, use of the “a” or “an” are employed to describe elements and components of the embodiments herein. This is done merely for convenience and to give a general sense of the description. This description, and the claims that follow, should be read to include one or at least one and the singular also includes the plural unless the context clearly indicates otherwise.

Upon reading this disclosure, those of skill in the art will appreciate still additional alternative structural and functional designs for the systems and a methods disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A charger for an electric vehicle, the charger comprising:
a battery system;
a high-voltage direct current (HVDC) bus configured to connect the charger to an external battery system;
a DC-to-DC converter; and
a switching component configured to (i) in a first operational state, connect the battery system to the HVDC bus directly so as to provide a parallel electric connection to the external battery system, and (ii) in a second operational state, connect the battery system to the HVDC bus via the DC-to-DC converter to align a voltage across the battery system with a voltage across the HVDC bus.

2. The charger of claim 1, wherein the switching component includes:
a power sharing contactor configured to electrically connect a first terminal of the battery system to a first wire of the HVDC bus, when the power sharing contactor is closed;
a rebalancing contactor configured to connect the first terminal of the battery system to the first wire of the HVDC bus via the DC-to-DC converter, when the rebalancing contactor is closed and the power sharing contactor is open;
wherein the second terminal battery is electrically connected to a second wire of the HVDC bus.

3. The charger of claim 1, wherein the DC-to-DC converter includes port contactors configured to connect to an electric vehicle, to transfer power from the battery system to the electric vehicle via the DC-to-DC converter.

4. The charger of claim 1, wherein the DC-to-DC converter is a buck-boost converter.

5. The charger of claim 1, further comprising:
an AC-to-DC converter configured to transfer power from an AC grid to the battery system.

6. The charger of claim 1, wherein:
the DC-to-DC converter is a first DC-to-DC converter;
the charger further comprising:
a second DC-to-DC converter connected to the battery system and configured to connect to an electric vehicle, to transfer power from the battery system to an electric vehicle regardless of whether the first DC-to-DC converter is currently operating to align the voltage across the battery system with the voltage across the HVDC bus.

7. The charger of claim 1, further comprising:
a communication module configured to receive, from a system controller external to the charger, a command for transitioning between the first operational state and the second operational state of the switching component.

8. The charger of claim 7, wherein the communication module is further configured to provide, to the system controller, one or more parameters of the charger.

9. A charging system comprising:
a first charger including (i) a first battery system, (ii) a DC-to-DC converter, (iii) at least one port configured to removeably receive connectors of electric vehicles, and (iv) a switching component;
a second charger including (i) a second battery system, and (ii) at least one port configured to removeably receive connectors of electric vehicles; and
a high-voltage direct current (HVDC) bus coupled to the first charger and a second charger;
wherein the switching component is configured to connect the first battery system to the HVDC bus via the DC-to-DC converter to align a voltage across the first battery system with a voltage across the second battery system.

10. The charging system of claim 9, further comprising:
a sensor configured to sense a voltage across the HVDC bus.

11. The charging system of claim 9, further comprising:
a controller system configured to (i) receive data from the first charger and the second charger, and (ii) determine one or more parameters of a unified battery system including the first charger and the second charger, using the received data.

12. The charging system of claim 11, wherein the received data includes a first charge current limit (CCL) of the first charger and a second CCL of the second charger.

13. The charging system of claim 11, wherein the received data includes a first discharge current limit (DCL) of the first charger and a second DCL of the second charger.

14. The charging system of claim 9, wherein at least one of the first charger and the second charger includes an AC-to-DC converter configured to transfer power from an AC grid to a battery system.

15. The charging system of claim 9, wherein the switching component includes:
a power sharing contactor configured to electrically connect a first terminal of the battery system to a first wire of the HVDC bus, when the power sharing contactor is closed;
a rebalancing contactor configured to connect the first terminal of the battery system to the first wire of the HVDC bus via the DC-to-DC converter, when the rebalancing contactor is closed and the power sharing contactor is open;
wherein the second terminal battery is electrically connected to a second wire of the HVDC bus.

16. The charging system of claim 9,
the DC-to-DC converter is a first DC-to-DC converter;
first the charger further comprising:
a second DC-to-DC converter connected to the battery system and configured to connect to an electric vehicle, to transfer power from the battery system to an electric vehicle regardless of whether the first DC-to-DC converter is currently operating to align the voltage across the battery system with the voltage across the HVDC bus.

17. A method implemented in a charger for an electric vehicle, the method comprising:
determining whether a voltage V_{BAT} across a battery system of charger differs from a voltage V_{HVDC} across a high-voltage DC bus to which the charger is connected by at least a threshold amount;
when V_{BAT} differs from V_{HVDC} by at least the threshold amount, transferring power between the battery system and the bus to reach a substantial alignment between V_{BAT} and V_{HVDC}; and
when V_{BAT} does not differ from V_{HVDC} by at least the threshold amount, connecting the battery system to the bus in parallel.

18. The method of claim 17, further comprising determining a charge current limit (CCL) of the battery system, wherein the transferring of the power between the battery system and the bus includes applying the CCL.

19. The method of claim 17, further comprising determining a discharge current limit (DCL) of the battery system, wherein the transferring of the power between the battery system and the bus includes applying the DCL.

20. The method of claim 17, further comprising:
subsequently to the transferring power between the battery system and the bus, determining that the substantial alignment between V_{BAT} and V_{HVDC} is reached; and
in response to the determining, connecting the battery system to the bus in parallel.
